(19) United States
(12) Patent Application Publication
(10) Pub. No.: US 2014/0212219 A1
(43) Pub. Date: Jul. 31, 2014

(54) ROLL-FORMED CONDUIT-ARCH FOR LEACH FIELD

(71) Applicant: E. Craig JOWETT, Rockwood (CA)

(72) Inventor: E. Craig JOWETT, Rockwood (CA)

(73) Assignee: ROWANWOOD IP INC., Rockwood (CA)

(21) Appl. No.: 14/167,218

(22) Filed: Jan. 29, 2014

(30) Foreign Application Priority Data
Jan. 29, 2013 (GB) 1301565.6

(51) Int. Cl. E03F 1/00; E02B 13/00; F16L 1/028; B21B 1/08; B21B 1/38

(52) U.S. Cl. CPC E03F 1/003; B21B 1/08; B21B 1/38; F16L 1/028; E02B 13/00
USPC 405/36; 72/199; 72/203

(57) ABSTRACT

In an apparatus for disposing of wastewater in subsurface soil, corrosion-resistant wire-mesh is formed by profile-rolling into a conduit-arch skeletal framework with open floor and is covered with non-woven geofabric. This conduit, set in excavated trenches to form a leach field and is buried with permeable soil cover, allows dispersal of wastewater throughout the trenches without distribution pipe or crushed stone, and allows substantial evaporation from the trenches and substantial air infiltration into the trenches to encourage aerobic degradation of organics and ammonium. The wire-mesh is derived from easily available coils sold for wire-mesh fencing.

This technology relates to the infiltration of water into the ground, and in particular to the treatment by aeration of wastewater such as septic tank effluent, and the disposal of the treated water by infiltration into the ground.

Some of the aims of the new technology can be summarized as:
to eliminate or reduce the need for such expensive-to-transport materials as crushed stone in large quantities in a leach field or sand-filter;
to provide an inexpensive way of forming an open conduit for creating a tunnel to be buried in a leach field, to disperse wastewater such as septic tank effluent into underlying and adjacent soil or sand;
to enable the needed apparatus to be lightweight and pre-assembled to enable easy installation by hand or with light equipment;
to provide for ample air to be available in the tunnel, to enable/permit substantial evaporation of water, and admittance of air to assist in the aerobic degradation of wastewater contaminants such as ammonium and dissolved organic matter.

Generally, an aim of the new technology is to provide an elongate tunnel, buried in the ground, and to enable water and air to enter and leave the tunnel. It is recognized that the conduit-arch by means of which the tunnel is created should be:
lightweight and pre-assembled for ease of installation;
compact and stackable for ease of long-distance delivery and warehousing;
open floor in design for use without a distribution pipe;
with bottom flanges or feet to distribute load into the underlying soil;
corrosion-resistant for longevity of use;
air permeable for improved aerobic treatment;
formed from widely available materials with little or no custom cutting;
manufactured using uncomplicated generally available techniques;
adaptable for manufacture in the field;
and generally low cost.

The following patent publications are considered relevant to the present technology:
U.S. Pat. No. 5,954,451 (Presby 1999);
U.S. Pat. No. 5,015,123 (Houck+1991);
U.S. Pat. No. 4,759,661 (Nichols+1988);
U.S. Pat. No. 4,588,325 (Seefert 1986);
U.S. Pat. No. 4,192,628 (Gorman 1980);
U.S. Pat. No. 4,182,581 (Uehara+1980);
U.S. Pat. No. 4,145,157 (Lascelles 1979);
U.S. Pat. No. 3,339,366 (Gogan+1967).

Specialists in the design of water infiltration systems will know how to ensure that, and how to measure whether, an in-ground installation is strong enough to withstand the operational stresses and abuses likely to be encountered, and be familiar with the relevant standards. Relevant also is the publication of Tyler, E. J. (2001) entitled ‘Hydraulic wastewater loading rates to soils’ in ‘On-Site Wastewater Treatment’ edited by K. Mancl, in ‘Proceedings of the Ninth International Symposium on Individual and Small Community Sewage Systems’. ASAE, St. Joseph Mich. pp 80-86.

As regards wire-mesh that is suitable for use in the present technology, the following publication is relevant: ‘Welded Wire Mesh’, www.ceshepherd.com/pdf/shepherd_welded_wire_mesh.pdf. The mesh is regular, i.e all the component wires are of the same thickness, and all apertures are same shape and size.

### Some of the New Technology

In the present technology, a flat wire-mesh sheet is derived e.g from a coil of wire-mesh fencing. The flat sheet is subjected to profile-rolling, and the sheet emerges from the profile-rollers as a conduit-arch. The conduit-arch is placed on the floor of an excavated trench, and a blanket of geotextile material is draped thereover. The trench is filled in—usually with the soil excavated from the trench—whereby the conduit-arch lies buried in the ground. In many cases, the to-be-infiltrated water is fed into the tunnel simply from an inlet at one end of the tunnel created by the conduit-arch. In other cases, a water-pipe is coordinated with the conduit-arch for supplying the water into the tunnel.

The conduit-arch being formed by profile-rolling, the length of the conduit-arch is not dependent on the size of the profile-rolling-machine, but only on the length of the sheet fed into the profile-rollers. The profile-rolling machine can be so structured as to be transportable by trailer or truck, whereby long lengths of the conduit-arch can be formed on site (from a coil of wire-mesh fencing), which is useful when long lengths of the conduit-arch (e.g ten metres and more) are required. In such cases, it can be more economical to transport the profile-rolling machine, and the coils of wire-mesh fencing, to the site than to make the conduit-arches in-factory in e.g three-metre lengths.

A wire-mesh sheet that is suitable as the material from which the conduit-arch can be formed, is welded wire-mesh fencing as sold in rolls or coils to be used as fencing. Mesh fencing suitable for present purposes is manufactured at a variety of locations and, because it is used for common purposes, is widely distributed and warehoused, and readily available at reasonable cost. Suitable mesh fencing comprises welded steel wire coated by corrosion resistant metal, polyvinylchloride, or other permanent coating. Particularly suitable is wire-mesh that is intended for use in marine water applications. Galvanized steel wire that may in addition be coated with plastic such as polyvinylchloride, or wire welded steel mesh that is hot-dipped galvanized or otherwise meets appropriate standards such as CSA B-66, is suitable for septic environments.

To be suitable for use in the present technology, the several wires of the wire-mesh should be immovable relative to each other (as by being welded together), and therefore chain-link fencing may be regarded as unsuitable. The expression ‘wire-mesh’, as used herein, should be construed to include mesh made in the form of expanded-metal, provided the apertures are large enough; the form of expanded-metal mesh known as flattened-expanded-metal is somewhat easier to form by profile-rolling (being of uniform thickness) than welded-metal wire mesh.

Also, perforated sheet-metal can be formed into conduit-arches by profile-rolling, and therefore can be suitable; however, unless the perforations in the sheet-metal are very large, perforated sheet-metal is too heavy, and too expensive, compared with regular wire-mesh fencing. The mesh format, in which the apertures are square, rectangular, hexagonal, etc in shape, is suitable in wire thicknesses of two mm or more greater, which is the preferred minimum size for the present technology. The preferred material is plastic-coated steel welded wire-mesh, which is widely available in e.g 1.2 metre widths, in e.g hundred-metre coils.

The widely-available e.g one-metre widths of fencing, 1.2-metres, and other standard widths, are suitable as the wire-mesh sheets from which the conduit-arch is to be formed by profile-rolling. At these standard widths, the sheet can be used as-is, in that there is no need to trim the edges of the sheet, for most tunnel widths required for septic trenches. Of course, the wire-mesh sheet needs to be cut to length, and three-metre, five-m, even ten-m lengths can be transported to the job site in ordinary vehicles or trailers, and can be installed by hand or with small machinery. Alternatively, especially when longer lengths of conduit-arch are required, a profile-rolling machine can be transported to the job site, and the conduit-arch can be formed on-site, saving time compared with joining smaller lengths and with no waste of material used on overlapping lengths.

In order to be self-supporting and to remain open during operation the chamber must be robust enough to withstand overburden pressures. The AASHTO ‘H-10’ loading rate of 16,000 lbs per axle under 12″ of compacted soil is cited as a suitable strength standard for septic chambers, but its mode of use and interpretation is undefined. Enermodal Engineering has proposed a more standardized test for the CSA B-65 standard that uses standard platen sizes to duplicate a truck wheel and which can be carried out by a testing laboratory under controlled conditions.

Mesh fencing is available in a variety of combinations of heavy wire with wider spacing (larger mesh apertures) and lighter wire with narrower spacing (smaller mesh apertures). The weight of metal per unit length (i.e the amount of metal in a coil of wire-mesh fencing) provides an approximate strength estimate.

Wire-mesh fencing is available also in the form of fence-panels, rather than in coils. In fence-panel form, the wire-mesh would generally not be suitable for use in the present technology. Such panels are generally more or less rigid, having been formed with rolled-over edges, stiffening ridges, and the like, whereby profile-rolling cannot be done economically.

A shallow depth of soil cover of twenty to forty centimetres over the roof of the conduit-arch is recommended for most dispersal applications, especially in tighter clay-rich soils, since the uppermost soil horizons are more permeable for easier dispersion laterally away from the trench walls. A covering of less than twenty cm is disadvantageous in that the chamber will not be protected from vehicles potentially driving over the area, and the soil might not be adequately thick for grass cover to become established. A soil covering of more than forty cm is disadvantageous in terms of reduced air-permeability, whereby the air needed to promote aerobic transformation reactions might not now be available.

Generally, the water that is to be infiltrated into the ground is sewage effluent wastewater from a septic-tank, and such effluent wastewater should be exposed to air (aerated) prior to entering the ground. The effluent wastewater contains ammonium, BOD, etc, which, if the water is aerated, are more or less transformed into harmless substances by aerobic microbiological action.

The present technology, though very-well-suited for use when it is required to aerate the water prior to infiltration, is also suitable for use when the water is simply to be infiltrated, and aeration is not required.

For present purposes, a profile-rolling machine is distinguished from a bend-rolling machine.

In a sheet-metal rolling machine, the material is passed through the machine in a feed-direction. The sheet metal has length, measured in the feed-direction, and has width measured at right angles to the feed-direction. The axes of the rollers are parallel to the width of the sheet material. For present purposes, it is assumed that the axes of the rollers are horizontal.

In bend-rolling, there are three rollers, the rollers being offset lengthwise with respect to the sheet (i.e in the direction of travel of the sheet). The sheet engages the three rollers—not simultaneously but—sequentially in 1-2-3 order. Roller-1 and roller-3 lie above the sheet, and roller-2 lies below the sheet (or vice versa). The rollers are so arranged that the sheet is forced to bend in passing between the rollers, and the axis of the resulting bend in the sheet is parallel to the width of the sheet. In bend-rolling, each roller extends across the full width of the sheet, and, in simple bend-rolling, the roller is uniformly right-cylindrical over that whole width.

In profile-rolling, the rollers are arranged in pairs, and there are several pairs of rollers. One roller of each pair lies above the sheet, and one below, and the sheet passes between the two. In profile-rolling, the desired profile is formed into the profile of the rollers themselves. The rollers of the first pair (i.e of the first active pair) are profiled to work on the sheet in its (usually flat) as-received form, and to impart a small element of the required final profile onto the sheet. The sheet emerges from the first pair, and passes to the next pair of rollers, which are profiled to receive the sheet in the slightly profiled form that emerges from the first pair, and to impart a further small increment of the final desired profile. The third, fourth, etc, pairs then in turn impart each their own small element of the desired final profile. The sheet emerges from the final active pair as a continuous length. In the continuous length of the emerging sheet, the desired final cross-sectional profile is present uniformly at each point along the length. In simple profile-rolling, the emerging sheet is in the form of straight channelling. That is to say: the emerging formed-profile sheet has zero curvature about a horizontal axis perpendicular to the length of the sheet.

A compound rolling machine combines bend-rolling with profile-rolling. In compound rolling, the emerging sheet has a profiled cross-section, and is also curved about a horizontal axis perpendicular to the length of the sheet. (For example, when the rim for an automobile wheel is formed from sheet steel, the cross-sectional profile of the rim is formed by profile-rolling, and the rim is bent into the required circular shape by bend-rolling.)

The present technology is concerned with simple profile-rolling. It is not concerned with bend-rolling nor compound rolling.

In profile rolling, the wire mesh material is so dimensioned and arranged, and in such condition of hardness and ductility, that the material is able to take a permanent-set upon passing through a pair of rollers. Simple profile-rolling cannot form the material into ribs and folds, and other compound forms, in that, in its final form, the profile-rolled material has the same cross-section at all points along its length. But there is no need, in the present technology, for the conduit-arch to have complex features that cannot readily be produced by simple profile-rolling.

It might be considered that the arch-form profile that is present in the conduit-arch could be produced by brake-bending.

However, brake-bending would require the provision of brake-bending form-tools having the full length of the conduit-arch. Of course, such large forming-tools (and the machine to operate them) can indeed be done—but not economically, given the nature of the market for small sewage wastewater disposal stations. Profile-rolling has the benefit that the rollers, and the associated machine, are much smaller than the corresponding brake-bending form-tools and machine.

In profile-rolling, the operation of forming the flat sheet into a conduit-arch occurs over only a short length of the sheet, and affects only the width of the sheet. In profile-rolling, the length of the sheet occupied by the (e.g four pairs) of rollers is not affected by whatever is the overall length dimension of the sheet. In profile-rolling, the whole length of the wire-mesh sheet contained in the as-purchased coil can be, and is, rolled to the required arch-form in a single pass through the rollers.

In most cases, a profile shape that can be produced by profile-rolling can be produced also by brake-bending. The aspect that makes brake-bending unsuitable for forming the conduit-arch described herein lies in the adverse economics of having to provide the large form-tools required for brake-bending.

### LIST OF DRAWINGS

The technology will now be further described with reference to the accompanying drawings, in which:

FIG. 1 is a pictorial view of a conduit-arch.

FIG. 2 shows a coil of wire-mesh sheet, being the starting material from which the conduit-arch is made.

FIG. 3 is the same view as FIG. 1, but now a water-pipe has been coordinated into the conduit-arch.

FIG. 4 shows an alternative conduit-arch. In FIG. 4, the conduit-arch and water-pipe are shown installed in an infiltration-trench in the ground.

FIG. 5 is a large-scale section showing the welding of the length-wires to the width-wires, and the PVC coating.

FIG. 6 is an end view of the conduit-arch of FIG. 1, showing progressive steps during forming by profile-rolling.

FIG. 7 is an end view of the coordinated conduit-arch and water-pipe of FIG. 3.

FIG. 8 shows the profile of another conduit-arch.

FIG. 9 shows a portion of the conduit-arch of FIG. 4. Here, the water-pipe has been omitted from the drawing.

FIG. 10 is the same view as FIG. 8, but shows yet another conduit-arch. Again, the water-pipe has been omitted.

FIG. 11 is the same view as FIG. 10, but shows a further conduit-arch.

FIG. 12 is the same view as FIG. 10, but shows yet a further conduit-arch.

The conduit-arch 20 shown in FIG. 1 is made from a sheet of steel wire-mesh. Such wire-mesh sheet material is obtainable in rolls or coils, being sold for use e.g as wire-mesh fencing. The wire mesh is protected by a coating of plastic—PVC, in the present case. The coils 23 are available in standard widths (corresponding to the height of the fence) of e.g 100 centimetres, 120 cm, 150 cm, etc. The coil 23 contains e.g 100 metres length of the wire-mesh fencing.

In the structures depicted in the drawings, the length-wires 25L and the width-wires 25W are of steel, of three millimetres diameter. The wires 25L,25W are pitched every five cm, on a square grid. The apertures 27 of the mesh are defined as the areas enclosed by the (coated) wires 25, the apertures 27 having each an open area of twenty-one sq.cm. The sheet of steel wire-mesh, as illustrated in the drawings, has a weight of two kilograms per square metre of the sheet.

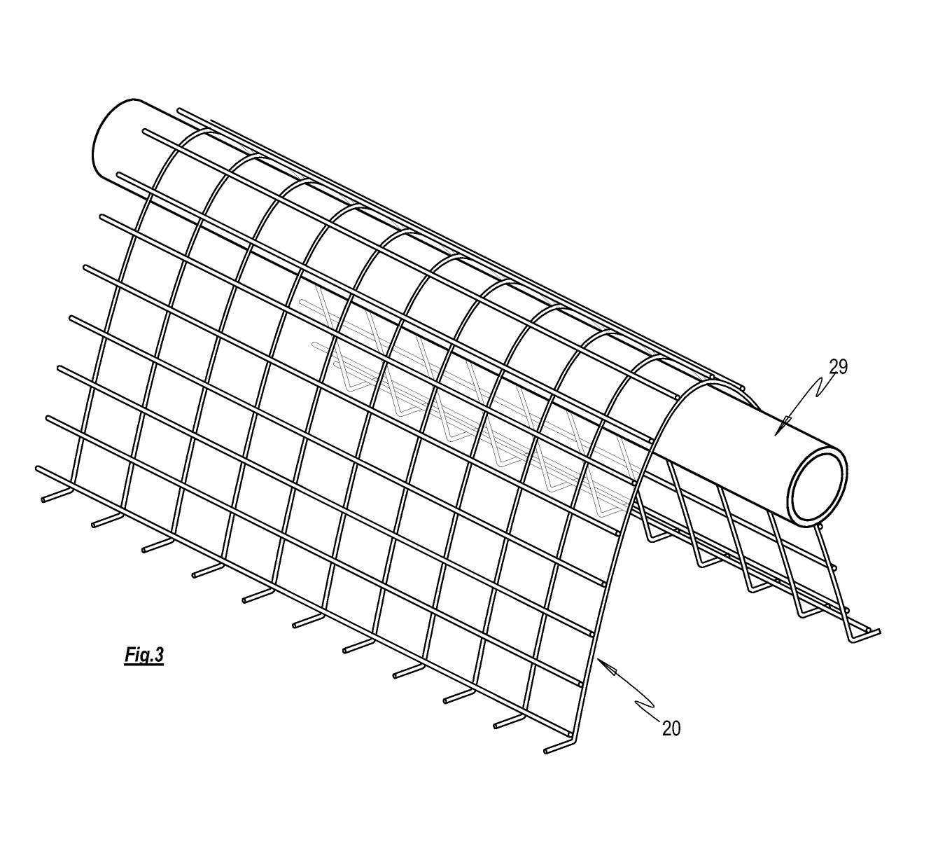

FIG. 3 shows a water-pipe 29 located inside, and just under the roof of, the conduit-arch 20. The water-pipe 29 is held fixed in that location by suitable hangers; in this case, the hanger is a strand of wire passed under the water-pipe 29 and looped through the apertures 27 in the mesh. (The roof of the conduit-arch is that portion of the wire-mesh sheet that faces upwards at an angle of less than thirty degrees to the horizontal; the left and right sidewalls lie at an angle of more than thirty degrees to the horizontal.)

Typically, the water in the water-pipe 29 is sewage water derived from a septic-tank. The water-pipe 29 is provided with holes through which the wastewater is ejected into the tunnel 30 created by the conduit-arch 20. The holes are arranged to jet the water downwards, sideways, and upwards; in an alternative, the holes are arranged to jet the water just downwards. As a general rule, the better-aerated the water, the lower the contamination will be in the water that enters the soil; and spraying the water on the roof and sidewalls of the tunnel 30 assists in aerating the water.

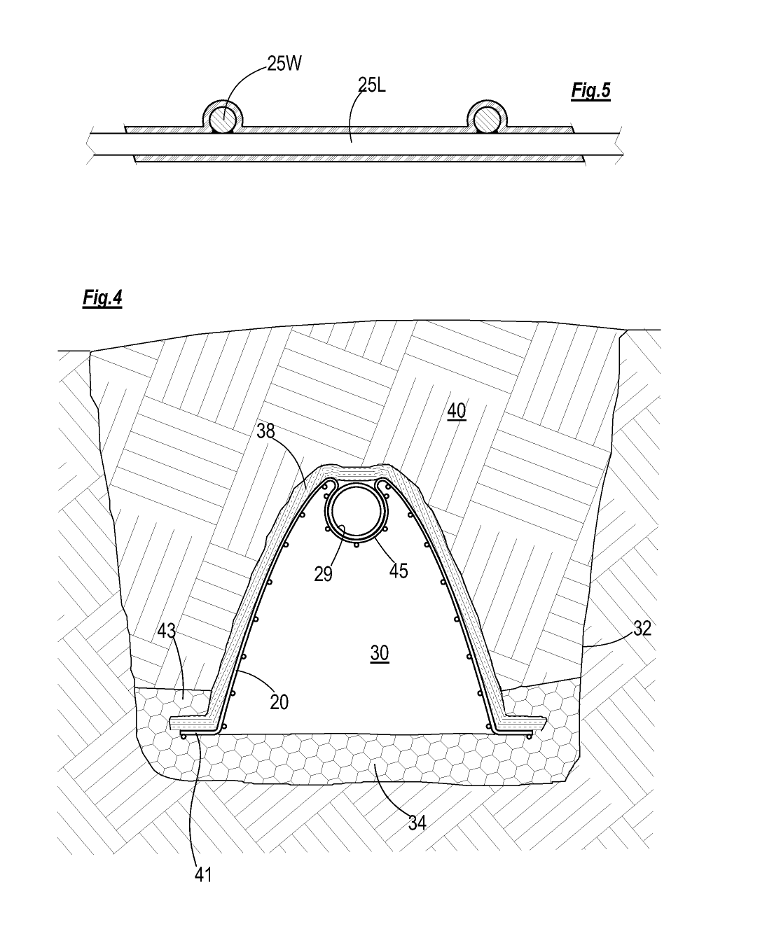

FIG. 4 shows the conduit-arch 20 installed in a trench 32 in a water-soakaway-station. In the example shown, the trench having been excavated, a layer 34 of pebbles, gravel, etc was placed on the floor of the trench 32. Water entering the soil having passed down through the layer 34 has almost zero velocity and energy, and physical erosion of the soil by the water is thereby eliminated /minimized.

As shown in FIG. 4, a blanket 38 of geofabric overlies the outside of the conduit-arch 20. The blanket 38 is very permeable to water and air. The purpose of the blanket 38 is to keep particles of the fill-in soil 40 from entering the tunnel, and the material should be selected accordingly. The blanket also serves the purpose of spreading the weight of the overlying soil evenly over the wire-mesh chamber, compressing the structure evenly and thereby adding to the strength of the structure as a standard arch under compression. With the blanket covering the chamber framework, any point-load, like a car-wheel, will be distributed over a larger area of the framework and bending of the framework will be minimized. As the blanket is forced downwards by the point-load, it pulls the blanket laterally to it, but as that is weighted down by the soil cover, the blanket is forced into tension and resists bending downwards into the framework. The blanket 38 should extend over the left and right feet 41 of the conduit-arch 20. In this case, the geofabric of the layer 36 was marketed under the trademark TERRAFIX 300R.

Preferably, the geofabric is non-woven. The fabric has little structural rigidity, but is strong in tension. The geofabric is required to span the apertures in the wire-mesh sheet, and to resist the pressure of the weight of the soil, which tends to make the fabric sag into the mesh apertures. Of course, a level of sagging into the apertures will occur. The designers should see to it that the geofabric is strong enough to support the pressure of the soil, given the size of the apertures in the particular mesh, and given the in-ground conditions of the soil.

The designers should see to it that the apertures 27 are not so large that the magnitude of the sagging could damage the blanket. The distance apart of the wires should be no more than ten cm apart, in order to contain the tendency of the blanket to sag inwards. Also, the areas of the apertures should not be greater than forty sq.cm.

In fact, in deciding whether a given aperture size is acceptable for present purposes, designers should pay heed more to the need for the conduit-arch to be physically strong than the need to support the blanket against sagging. The pitch of the width-wires is the main determinant of strength, and the pitch should be related to the thickness of the wire: thus, the wire being of thickness T, the width—wires should be pitched not more than P cm apart, where P is T×2.5. (Thus, where T is two mm, P should not be more than five cm, and so on.) For the same reason, the area of the apertures should be no more than A sq.cm, where A is T×10. (Thus, where T is four mm, A should not be more than forty sq.cm.) At the same time, for ease of the profile-rolling process, the weight of the wire-mesh sheet should not exceed three kg/sq.m.

In some cases, the nature of the soil of the floor of the trench 32 is such that no pebbles etc need be added for controlling erosion, and the water can be allowed to infiltrate directly onto the bare soil. Alternatively, since most of the kinetic energy of the water is expended in the first few metres of the length of the tunnel, only the first few metres need be covered with pebbles.

It may be noted that the quantity of pebbles, gravel, etc that is needed just to cover the floor of the trench is quite small, compared with the large quantities of such material needed in traditional aerobic soakaway installations.

Designers can prefer that another layer 43 of pebbles be placed on top of the feet 41—i.e on top of the portions of the blanket 38 that overlie the feet. It is preferable, when the water is infiltrating into the ground, for the water to spread out laterally into the soil off to the right and left of the conduit-arch 20, as well as straight down into the soil of the floor of the tunnel 30. Placing pebbles around the feet 41 enables water to flow laterally, to right and left, without the ground being damaged by erosion. Again, the quantity of pebbles needed to achieve this is minuscule compared with the quantities used in traditional soakaways.

As mentioned, in the drawings, the steel wires 25 are of three mm diameter, and are pitched in five cm squares. The apertures 27 have an open area of twenty-one sq.cm. The sheet of steel wire-mesh has a weight of two kg/sq.m of the sheet. At this, the conduit-arch 20 is strong and rigid enough to retain its shape and to support the weight of the fill-in soil 40 above the conduit-arch—and the weight of such loads as might be applied thereto. It is convenient, but not essential, that the apertures 27 be square, and regular, and be all of the same size.

The structure of the conduit-arch 20—being an open mesh—is highly permeable to air. Thus, whether there is enough air present in the tunnel 30, to ensure full aeration and to maximize the oxidation reactions, does not depend on the conduit-arch, nor on the geotextile blanket 38 but on the depth of the fill-in soil 40. The geofabric blanket 38, though of course less air-permeable than the open wire-mesh, is still much more air-permeable than the body of fill-in soil 40. The maximum depth of the fill-in soil 40 that can be allowed, to avoid stifling the tunnel of air, depends on the permeability of the soil. To ensure good aeration in clayey soils, the roof of the conduit-arch 20 should be under no more than twenty cm of fill-in soil, and no more than thirty cm in sandy soils.

Generally, the sewage water that is to be aerated and then infiltrated into the ground arrives in the water-pipe 29 in intermittent doses. The holes in the pipe 29 should be small enough that the rate of outflow (litres/second) of water from the pipe, through the holes, is much smaller than the rate (litres/sec) at which the dose is filling the pipe. The designers should see to it that the dose is large enough to fill the water-pipe 29, whereby hydraulic pressure can be applied to the water in the pipe. This application of pressure ensures that the water flows right to the far end of the pipe, whereby the rate of flow through the holes can be reasonably even over the length of the pipe. The designers can arrange for the size of the holes at the far end of the pipe to be larger than the holes near the inlet—again to even out the discharge rate over the length of the pipe, where that is deemed desirable.

In some jurisdictions, when a water-pipe is used in conjunction with an engineered soakaway, there is a requirement that the water-pipe must be replaceable—i.e, that a clogged pipe can be extracted, and a new pipe inserted, without the need to remove the fill-in soil. In the present case, if the water-pipe 29 is located underneath the roof of the conduit-arch (FIG. 3) the water-pipe is removed from the tunnel by pulling the pipe lengthwise through the tunnel, from the end of the tunnel, or from some intermediate access point. The replacement water-pipe is inserted lengthwise, in like manner. It is a simple matter for the designers to so arrange the manner of supporting the pipe in the tunnel that such replacement is possible and practical, if such is required.

However, when the water-pipe 29 is located in a recess 45 of the wire-mesh, on top of the roof of the conduit-arch (as in FIGS. 8,11,12), now the water-pipe is itself, at least partly, holding up the weight of the fill-in soil 40. As a result, when the pipe is removed (lengthwise), the weight of the above-soil causes the blanket to sag downwards, thereby (partially) closing off the recess 45, and making it impossible for the replacement water-pipe to be inserted lengthwise back into the recess. The geotextile fabric material of the blanket 38 has zero compressive strength, and cannot take the weight, itself, of the above-soil, unless the weight stresses the blanket in tension. Thus, a conduit-arch having the profiles shown in FIGS. 8,11,12 is contra-indicated when the rules require the water-pipe to be replaceable.

A conduit-arch having the profile shown in FIGS. 4,9, however, means that the water-pipe can be withdrawn by pulling the pipe out of the tunnel in the lengthways direction, even though the water-pipe lies outside the conduit-arch. Also, the weight of the water-pipe is entirely supported in and by the conduit-arch (as it is in FIGS. 8,11,12) without the need for hangers.

In FIGS. 4,9, the wire-mesh is formed with left and right ears that are so shaped as to extend upwards above the top of the pipe, upon installation in the ground. Thus, when the blanket 38 of geofabric is draped over the conduit-arch, and over the water-pipe, now the geofabric spans across between small gap between the tips of the ears. There will be a certain amount of sagging downwards—but, as shown in FIG. 4, the designers arrange for the magnitude of the down-sagging to be small enough to leave the bottom of the fabric clear of the top of the water-pipe. Thus, when the water-pipe is pulled out lengthways, the fabric does not drop down and block off the recess, and there is no impediment to the re-insertion of the new water-pipe.

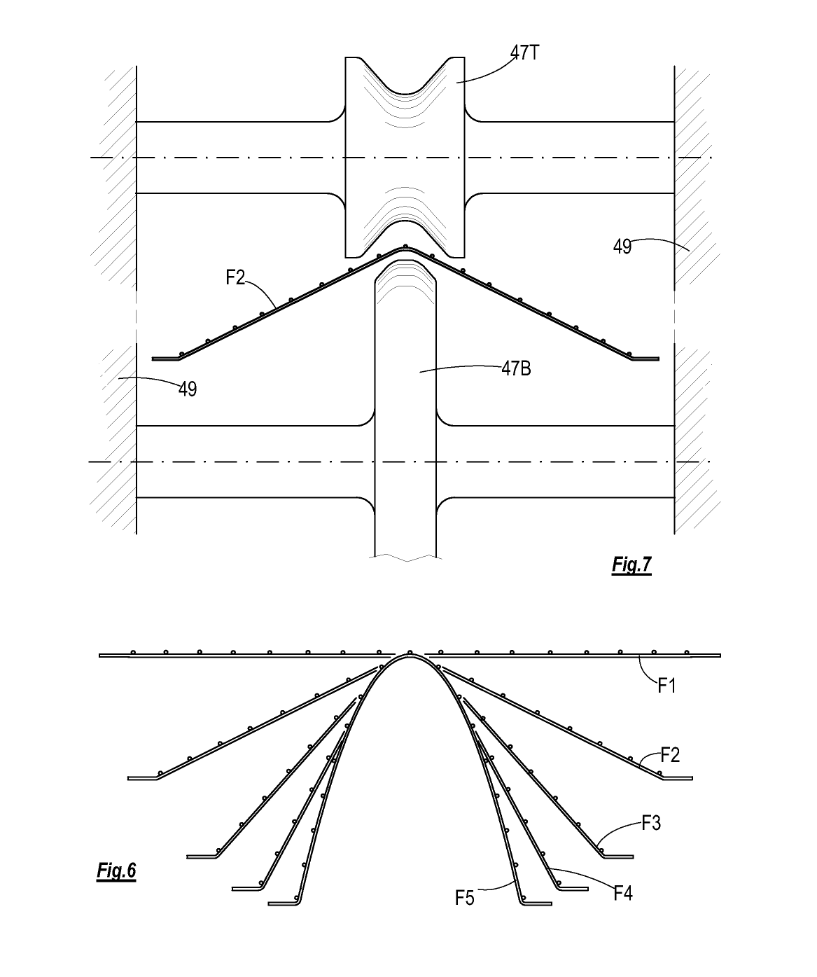

FIGS. 6,7 illustrate the profile-rolling process. Aspects of profile-rolling not described herein are well-known to specialists in the design, manufacture, and operation of profile-rollers and rolling machines.

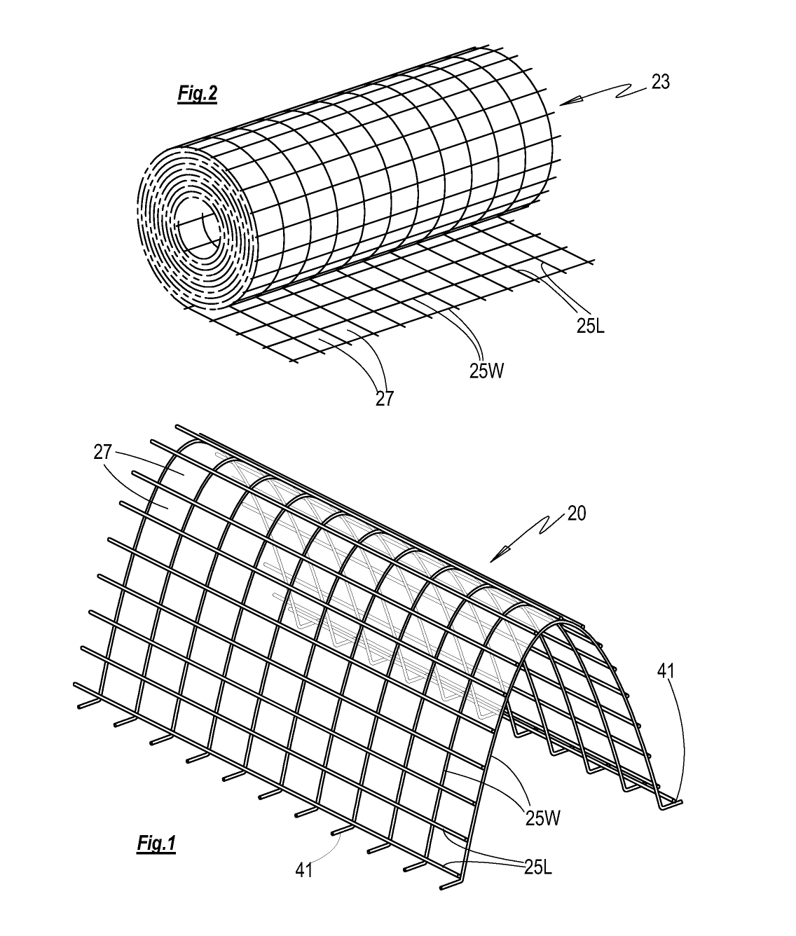

The flat sheet (FIG. 2) of wire-mesh, from which the conduit-arch 20 is to be made, is accessed simply by unrolling the coil 23. The wire-mesh sheet passes through the rolling-machine between successive pairs of rollers. For rolling the profile as shown in FIG. 2, typically four pairs of rollers are provided, creating the four sequential forms F1,F2,F3,F4,F5 as shown in FIG. 6, where F1 is the flat sheet, and F5 is the finished conduit-arch. Thus, the complete profile is formed in four increments.

Generally, the conduit-arch as a whole should have zero curvature about an axis that lies in the plane of FIG. 6. That being so, the designers should arrange for the two rollers of the pair to lie one substantially vertically above the other, and substantially parallel to each other. Mismatch of the rollers (e.g one behind the other in the direction of travel of the sheet) would introduce a longitudinal curvature into the conduit-arch, which generally (though not essentially) would be detrimental.

FIG. 7 shows the second pair of rollers, being the rollers that will receive the sheet in the already-created profile-form F2, and the sheet will emerge from this second pair with the profile-form F3. In FIG. 7, the bottom-roller 47B straddles between left and right bolsters 49 of the rolling-machine. The shaft of the bottom-roller 45B is mounted in suitable bearings fixed into the bolsters 49. The bottom-roller 47B is provided with a convex form, and the top-roller 47T with a corresponding concave form. The convex and concave forms conform to the profile-form F3.

The plane of the cross-section of FIG. 7 is the vertical plane through the axes of the rollers. (In FIG. 7, the direction of travel of the sheet through the rolling-machine is horizontal, into the paper.) The rollers 47 are shown spaced apart in FIG. 7, for clarity, but of course in operation the rollers are close together, the gap between them being only sufficient to allow the thickness of the sheet to pass through.

In the present case, the sheet comprises a mesh of length-wires and width-wires, the wires being welded together at the junctions. Thus, the sheet does not present a uniform thickness to the profile rollers 47. When profile-rolling a constant-thickness plain sheet of metal, the gap between the rollers is a tight fit on the thickness-Tmm of the sheet, i.e the rollers are spaced the Tmm apart—but in the present case, the distance apart of the rollers 47 should be the sum of the thicknesses of the length-wire plus the width-wire. Only the width-wires are bent into the curved arch-form; the length wires remain straight.

As far as profile-rolling is concerned, it does not matter whether the length-wires lie on the convex side of the curve of the width-wires, or on the concave side.

It can sometimes be advantageous for the top and bottom rollers to be in direct touching contact with both the top and the bottom of the width-wires, during rolling. To do that with the welded wire-mesh, circular grooves can be cut in the profiled surface of the rollers, and the wire-mesh sheet then is so fed through the rollers that the length-wires fit in these grooves during the rolling operation. Now, the curvature imposed on the width-wires can be more exactly controlled. Sometimes, the welded junctions between the wires can tend to be damaged by a rolling operation like that of FIGS. 6,7, and such tendency can be reduced when the welded junctions—residing in the grooves—are not being stressed by the rolling operation.

In this specification, the term ‘curved’, as applied to a width-wire, applies generally to the width-wire as a whole length. It should be understood that a conduit-arch, overall, can be ‘curved’, as that term is used in the present sense, even when the width-wires are actually bent at spaced intervals, and the portions of the width-wires between those bent-areas are substantially straight. (The bent-areas might or might not be the areas of the welded junctions between the width-wires and the length-wires.)

For present purposes, the width-wire is regarded as being ‘straight’ between two points, six cm apart, if the difference between the tangential angles of the width-wire at these two points is less than three degrees. (This corresponds to a radius of curvature of approximately one metre).

The curvature of the conduit-arch is advantageous because the force that would cause the conduit-arch to distort inwards (e.g due to a sideways-force acting on the conduit-arch, or e.g due to pressure arising due to the weight of the fill-in soil, or e.g due to the weight of something resting on the fill-in soil) is much greater than the force that would cause a straight-sided-form to distort inwards.

That is to say: a straight-sided-form has a much smaller ability to support a force tending to distort it than a curved-form. It will be understood that a curved-form that has been formed as a series of bent-portions and straight-portions, is still curved, overall, and is (or can be) almost equally able to support imposed loads as (and in the same manner as) a smoothly-curved form. In fact, an arch that has been formed as a series of bends and straights is barely visibly different from a smoothly-curved arch.

It may be regarded, for present purposes, that so long as the conduit-arch looks or appears or seems to have a curved form as to its roof and side-walls, it will perform as if it had a smoothly-curved form. For present purposes, however, the straight portions (if such are present) of the width-wires of the conduit-arch preferably—the diameters of the wires being three mm—should not be longer than six cm.

In this specification, some of the given dimensions are related to wire-mesh in which the diameter of the wire is three mm. In structures where the wire is of greater or lesser diameter, these given dimensions should be increased or reduced proportionally.

The metal (steel) wire should be in such metallurgical condition that the metal can yield, and permanent bending of the width-wire can take place, without damage to the wire.

Also, the PVC coating must be strong enough, and flexible enough, that the coating survives intact when the metal of the wire is bent. Alternatively, designers can arrange for the wire-mesh sheet to be passed through the profile-rolling machine before the PVC coating is applied to the wire. That is to say: in this alternative, the PVC coating is applied to the conduit-arch after the conduit-arch has been formed.

As mentioned, sometimes the water-pipe must be replaceable without the need to excavate the infiltration station. The arrangement of e.g FIG. 8 would not be suitable in such an installation, because the geotextile blanket is supported—not solely by the conduit-arch, but—partly by the water-pipe itself. If the water pipe were to be withdrawn, the blanket would collapse, and the new water-pipe could not then be replaced. But where replacement is not required, the FIG. 8 design is advantageous, in that the water-pipe simply rests in a channel or trough in the roof of the conduit-arch, and the pipe is assembled to the conduit-arch simply by laying the pipe in the trough after the conduit-arch has been assembled into its final resting place in the trench.

The channel or trough of FIG. 8 is profile-rolled into the arch-form of the conduit-arch, at the same time as the arch itself is being formed. The rollers are more complicated, as compared with the rollers needed for the profiles shown in FIGS. 2,3,6,7, but the FIG. 8 shape, with its trough in the roof, can be produced by profile-rolling.

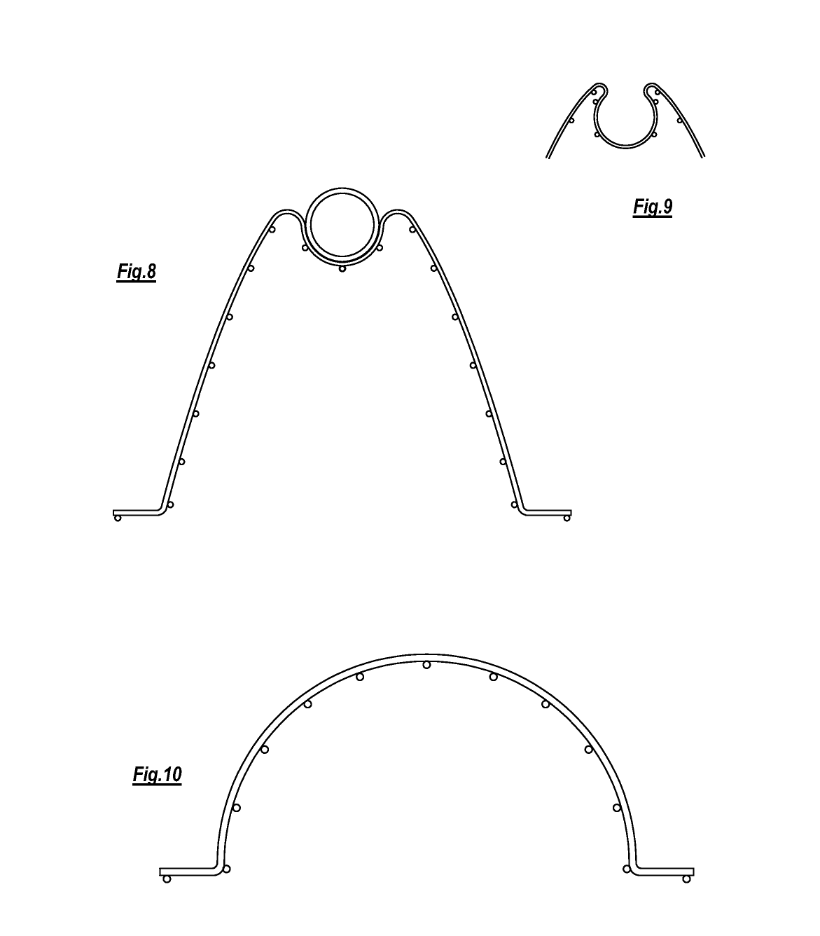

In FIG. 9, the conduit-arch has the same form as that shown in FIG. 4. Now, the water-pipe cannot be simply laid down in the trough from above, but must be threaded lengthwise into the trough, from one end. Again, the FIG. 9 shape, with its awning-cover over the water-pipe, poses more complexity as regards the shape and sequencing of the rollers, but the shape can be produced by profile-rolling.

The conduit cross-section should be shaped to withstand the in-ground load forces, both vertical and lateral. Attention to lateral force can be important in an unconsolidated and wet medium such as soil or sand where lateral movement may be considerable.

In FIG. 10, the width-wires have been bent into a semi-circle, by profile-rolling. Of course, the FIG. 10 profile is twice as wide as it is high, which might make it unsuitably wide for use in some installations. But the semi-cylindrical conduit-arch of FIG. 10 is very strong and rigid, which can be decisive where those qualities are especially required.

The FIG. 10 conduit-arch is strong and rigid in resisting lateral forces that might be applied to the conduit-arch. Lateral forces on the tunnel can arise, for example, when the infiltration station is located on sloping ground. (A hillside is generally a good location for an infiltration-station, in that gravity can be made to assist the flow of water through the station, and problems of rising water tables are less frequently encountered.)

Sometimes, however, designers, faced with the possibility of lateral forces on the tunnel, prefer to use a design that bends and absorbs and accommodates lateral movement, rather than one that stands firm against such movement. This is true especially if the lateral forces come and go. In that case, when the lateral force—having waxed—wanes, a resiliently-flexible conduit-arch, having bent, will revert to its original shape. The presence of a trough in the roof of the conduit-arch can serves to add such resilient flexibility.

Thus, a possible disadvantage of providing a rigid conduit-arch, as in FIG. 10, can arise as follows. When the conduit-arch is very stiff, a lateral rightwards force on the conduit-arch would or might cause the conduit-arch to tip or pivot about the right foot, and the left foot 41 to rise clear of its resting place against the floor—which might allow silt, fines, etc to enter the tunnel.

By contrast, the conduit-arch of e.g FIG. 4 is capable, as a whole structure, of deflecting in response to a lateral force applied horizontally. (It is often the case, in sewage treatment soakaways, that such lateral movement of the soil can occur.) The presence of the recess in the roof gives the roof some lateral resilient flexibility, without compromising the ability of the conduit-arch to support the weight of the fill-in soil. Thus, lateral distortion of the conduit-arch causes the roof of the conduit-arch to undergo a twisting movement (in the plane of the cross-section). The conduit-arch returns resiliently to its undistorted form if/when the lateral forces later disappear.

FIG. 11 shows a variant of the feet, in which the feet now are directed inwards rather than outwards. This shape is also readily profile-rollable. The preferred configuration is with outward facing flanges so that the conduit-arches can be stacked more readily. The feet serve to ensure even transfer of the weight of the body 40 of fill-in soil down to the floor of the trench. In cases where the weight can be supported without feet, feet can be omitted.

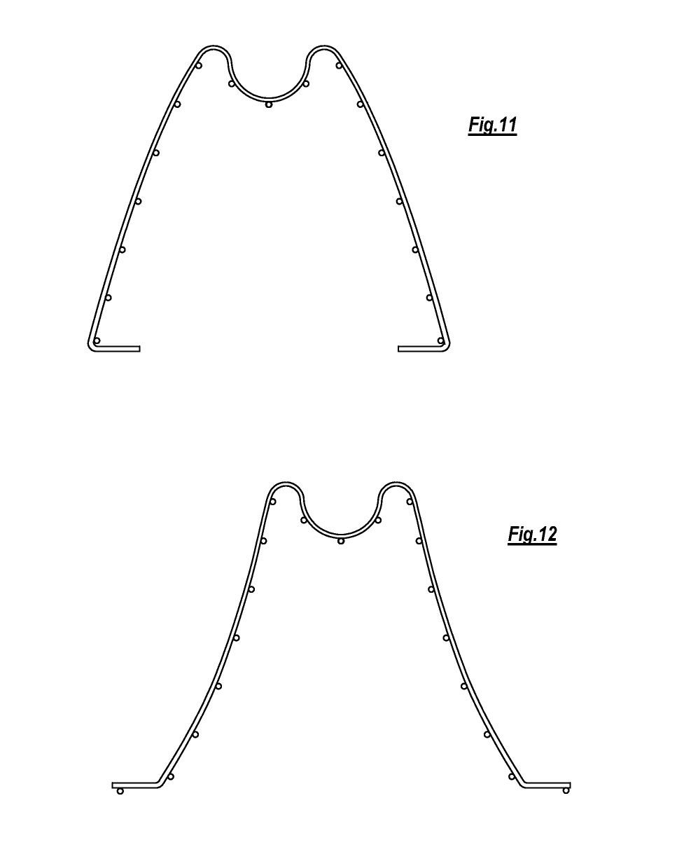

In FIG. 12, the side-walls of the conduit-arch are curved inwards. The designers wish that the side-walls of the conduit-arch should be highly resistant to inwards deflection. For this reason, the side-walls should be curved. A flat-plane or straight side-wall will undergo significantly greater deflection when subjected to a given pressure (kg/sq.m) of the fill-in soil pressing against the side-wall. However, the curvature of the side-walls can be convex or concave, i.e the profiles of FIG. 8 and FIG. 12 are substantially the same as regards ability to resist inwards deflection.

The tunnel created in the trench by the presence of the conduit-arch should be closed at its longitudinal ends. Designers should see to it that silt etc cannot enter through the ends of the tunnel. This can be done by extending the blanket 38 of geotextile fabric around the end of the conduit-arch. If necessary, a support framework, e.g of wire mesh, can be placed over the end of the tunnel, to support the extension.

The conduit-arch can be arranged to form one long tunnel. Or the tunnel can be provided as a series of shorter tunnels, arranged in a suitable layout, such a zig-zag, parallel rows, and the like.

It can be advantageous if the conduit-arch can be so profiled that lengths of the conduit-arch can be stacked on top of each other, for ease of warehouse storage and transport. The profile depicted in FIG. 1 is eminently stackable. The profiles depicted in FIGS. 8,11,12 are somewhat less conveniently stackable, due to the presence of the recess in the roof. The recesses depicted in FIGS. 4,9 is still less so, due again to the recess in the roof. The profile depicted in FIG. 10 could be made well-stackable if the side-walls were splayed slightly. The profile of FIG. 11 is really not stackable, due to the presence of the inwards-facing feet.

If desired, a floor-mat can be placed over the floor of the trench, to protect the soil from erosion. The material of such floor-mat should be inert with respect to the water and to the contaminants therein (i.e inert in the senses that: (a) the material is unaffected by the water, and (b) the water entering the ground has not picked up anything from the material), and should be of such structure as to take out all or most of the kinetic energy of the water filtering through the material. Also, the material should retain such fine silt particles as do make their way into the tunnel, preventing same from entering, and perhaps clogging, the soil of the floor of the trench. A favoured material is plastic fibre matting in which plastic threads or filaments present a tangled mass.

It has been mentioned, given the typical standard widths of the coils, that the wire-mesh can be used directly from the coil without the need for any trimming of the edges of the wire-mesh.

Of course, the conduit-arches have to be cut to length, i.e a cut has to be made across the width of the sheet, and the systems-designers should make provision for cutting across the width of sheet, to create lengths of the conduit-arch that suit the particular installation. However, it would be greatly troublesome to have to reduce the width of the wire-mesh sheet by making a lengthwise cut. It is recognized that the need for such lengthwise cutting can be eliminated or reduced, in the present technology.

As mentioned, the PVC-coated wire-mesh sheet is very commonly available, being sold in hardware stores etc for use as fencing, and the sheet comes in rolls or coils in which the width of the sheet is uniform and standardized to e.g 100 centimetres, 120 cm, 150 cm, etc. It is recognized that a sheet having one of these standard widths, i.e the sheet in its as-purchased width, and not having been trimmed as to its width, when formed by profile-rolling, gives rise to a conduit-arch of such height and footprint dimensions as to be well-suited, as-is, for use in trenches having the typical width and depth dimensions of traditional small sewage disposal installations.

The floors of such trenches are typically, for example, fifty cm wide and sixty cm deep. (Of course, there is considerable variation in trench dimensions, as dictated by the topography of the installation site, the nature of the soil, and so on.) A conduit-arch that has been profile-rolled from a standard-width coiled-sheet of wire-mesh fencing, will be, typically, twenty to forty-five cm high, and thirty to forty cm wide. The limit of width can be regarded as seventy cm, and the limit of height as sixty cm. Larger than that, the installation would not be the kind of small installation that can most benefit from the present technology.

Again, it would pose large difficulties if the edges of the wire-mesh sheet had to be cut, in order to make the sheets suitable to be profile-rolled into the conduit-arch form. It is recognized that the readily-available coils are already of a suitable width, i.e come in a range of standard widths, such that such edge cutting is not required. It is recognized that the overall arcuate length of the arch, plus the flanges /feet, can be equal to the width of the roll, as manufactured, so the wire-mesh need only be cut into lengths.

The water-pipe 29 is perforated, giving rise to holes through which water sprays into the tunnel. The wastewater is applied to pipe in periodic doses, and the holes should be suitably sized such that the water does not all emerge from a few holes near the inlet to the water-pipe, but such that the water travels to the far end of the water-pipe, and rains down at more or less the same rate over the whole length.

Preferably, in the present technology, the sheet comprises wires of steel which surround and define open apertures. The wire thickness should be no thinner than two mm. If the wire were thinner than that, the required strength and rigidity of the conduit-arch would or might be inadequate. Also, the wire thickness should be no thicker than four mm. If the wire were thicker than that, the sheet would be too stiff to be conveniently formed into the conduit-arch profile by the technique of profile-rolling. Also, the sheet should be no heavier than three kilograms per sq.metre; if more, the lengths of the conduit-arch would be too heavy for convenient handling, and again the sheet would be too stiff to be economically formed into the conduit-arch profile by the technique of profile-rolling.

The conduit-arch formed from the wire-mesh of which the wires have these dimensions has adequate strength and rigidity. At the same time, espeically in view of the weight limit of three kg/sq.m, such wire-mesh is pliable enough that it can be readily formed into the required arch-shape by profile-rolling.

Some of the components and features in the drawings have been given numerals with letter suffixes, which indicate related versions of the components. The numeral without the suffix has been used herein to indicate the components generically.

Some of the physical features of the apparatuses depicted herein have been depicted in just one apparatus. That is to say, not all options have been depicted of all the variants. Skilled designers should understand the intent that depicted features can be included or substituted optionally in others of the depicted apparatuses, where that is possible.

Terms of orientation (e.g “up/down”, “left/right”, and the like) when used herein are intended to be construed as follows. The terms being applied to a device, that device is distinguished by the terms of orientation only if there is not one single orientation into which the device, or an image (including a mirror image) of the device, could be placed, in which the terms could be applied consistently.

Terms used herein, such as “cylindrical”, “vertical”, and the like, which define respective theoretical constructs, are intended to be construed according to the purposive construction.

The scope of the patent protection sought herein is defined by the accompanying claims. The apparatuses and procedures shown in the accompanying drawings and described herein are examples.

The numerals used in the drawings are summarized as:
20 conduit-arch
23 roll or coil of wire-mesh fencing
25L,25W steel length-wires, width-wires
27 apertures in the mesh
29 water-pipe, contains sewage water to be aerated and infiltrated
30 tunnel created within conduit-arch
32 trench excavated in ground
34 layer of pebbles on floor of trench
38 blanket of geotextile fabric, overlying the conduit-arch
40 fill-in soil, overlying the conduit-arch
41 left and right feet of the conduit-arch
43 layer of pebbles overlying the feet of the conduit-arch
45 recess in the roof of the mesh conduit-arch
47B,47T bottom-roller, top-roller (FIG. 7)
49 side-bolsters of rolling machine.

1. Procedure for making a conduit-arch, wherein the procedure includes:
providing a sheet of metal;
creating a conduit-arch, in which the sheet is shaped into an arched-tunnel form;
creating the conduit-arch by profile-rolling.

2. As in claim 1, wherein:
the sheet is a sheet of metal wire-mesh material;
the sheet comprises wires of steel which surround and define open apertures.

3. As in claim 2, wherein:
the wire is of thickness T mm;
T is not less than two mm;
T is not more than four mm;
the sheet is no heavier than three kilograms per sq.metre of the sheet.

4. As in claim 3, wherein the sheet includes width-wires and length-wires, and the width-wires are pitched not more than P cm apart, where P is T×2.5.

5. As in claim 1, including deriving the sheet by uncoiling a coil of the sheet, the coil being coiled about an axis parallel to the width of the sheet.

6. As in claim 1, including, after profile-rolling:
cutting the conduit-arch to convenient length; but
leaving the edges of the width untrimmed and unchanged and the same as on the roll or coil.

7. As in claim 1, including so profile-rolling the conduit-arch as to form side walls and a roof therein, and to impose substantial permanent curvature into the sidewalls and roof.

8. As in claim 7, wherein any straight portions of the side-walls and roof are no more than six cm long.

9. As in claim 1, wherein: //
the sheet has a width W, and the length of the sheet is longer than the width W;
the sheet is of width equal to the width W at all points along the length of the sheet.

10. As in claim 1, wherein the arc-length of the conduit-arch, including the length of any feet of the conduit-arch, is equal to the width W of the sheet in the coil.

11. As in claim 1, wherein profile-rolling the arched-tunnel form into the flat sheet is effective to create the conduit-arch by permanently deforming the metal of the sheet.

12. As in claim 1, including:
where the profile-rolled conduit-arch includes curved left and right side-walls, and a curved roof, and the conduit-arch is open at the bottom;
so arranging the conduit-arch on the floor of the trench that the bottoms of the side-walls of the conduit-arch are constrained and prevented from moving apart by their interaction with the floor of the trench.

13. Procedure for infiltrating water into the ground, wherein the procedure includes:
making a conduit-arch by the procedure of claim 1;
placing the conduit-arch on the floor of an infiltration trench in the ground.

14. As in claim 13, wherein the water is effluent-water from a septic tank, or other water treatment station in which anaerobic transformation reactions were promoted.

15. As in claim 13, including so coordinating the conduit-arch with a water-pipe that water fed into the water-pipe emerges from the water-pipe onto the floor of the trench, inside the conduit-arch.

16. As in claim 15, including profile-rolling a recess in the roof of the conduit-arch, and laying the water-pipe downwards into the recess.

17. As in claim 15, including:
profile-rolling a recess in the roof of the conduit-arch, where the recess include ears that are a shorter distance apart than the diameter of the water-pipe;
inserting the water-pipe into the recess in the longitudinal direction of the conduit-arch.

18. A soakaway apparatus, for infiltrating water into the ground, wherein:
the water is conveyed into the apparatus via an inlet port;
the apparatus includes a conduit-arch, which has been manufactured by a procedure that embodies claim 1;
the conduit-arch is structured for location in a soakaway trench in the ground.

19. As in claim 18, wherein the apparatus includes a water-pipe for conveying water from the inlet port, into, and along the length of, the conduit-arch.
